(19) United States
(12) Patent Application Publication
(10) Pub. No.: US 2022/0380002 A1
(43) Pub. Date: Dec. 1, 2022

(54) Water Sports Equipment

(71) Applicant: ROSEN SWISS AG, Stans (CH)

(72) Inventor: Hermann Rosen, Kastanienbaum (Horw LO) (CH)

(21) Appl. No.: 17/755,551

(22) PCT Filed: Nov. 2, 2020
(86) PCT No.: PCT/EP2020/080702

§ 371 Date: May 2, 2022

(30) Foreign Application Priority Data
Nov. 1, 2019 (DE) 10 2019 129 574.2

(51) Int. Cl. B63B 32/10; B63B 32/64; B63B 1/24; B63B 79/40; B63B 79/10; G05D 1/02; B63B 1/30

(52) U.S. Cl. CPC B63B 32/10; B63B 32/64; B63B 1/246; B63B 79/40; B63B 79/10; G05D 1/0206; B63B 1/30

(57) ABSTRACT

A water sports device is provided in which a propulsion device has at least one sensor arrangement which is usable for position determination. A control unit of the water sports device is designed for generating control signals on the basis of signals from the sensor arrangement for the purpose of geofencing and/or homing. One or more controllable elements of the water sports device are activated by means of the control signals. Such elements may include a motor of the propulsion device, movable means for generating an alignment of a water jet (e.g. a wing, motor, rudder blade, a fin and/or nozzle), and/or retractable and extendable elements (a centerboard, a holding and/or hydrofoil device) which influence the floating properties of the water sports device.

### CROSS REFERENCE

This application claims priority to PCT Application No. PCT/EP2020/080702, filed Nov. 2, 2020, which itself claims priority to German Patent Application No. 10 2019 129574.2, filed Nov. 1, 2019, the entirety of both of which are hereby incorporated by reference.

### FIELD OF THE INVENTION

The present invention relates to a water sports device, in particular a foil board, having a floating body, preferably in the form of a swimming board, and a propulsion device provided for propelling the water sports device.

Such a water sports device is designed in particular as a foil board when the floating body is designed as a swimming board and has at least one hydrofoil device with one, in particular with at least two, hydrofoils. Such water sports devices are regularly used to move people located on the side of the floating body facing away from the hydrofoil device over bodies of water. During the locomotion, the hydrofoil device is regularly arranged below the water surface.

Another water sports device can be designed, for example, as a diving propulsion vehicle.

### BACKGROUND OF THE INVENTION

US 2018/0072383 A1 discloses a foil board having a hydrofoil device which, because of the foil used, requires a sufficiently deep body of water, since the hydrofoil device will otherwise touch the ground and be damaged. Regions of a body of water that are remote from a bank or beach are therefore regularly required for the use.

### BRIEF SUMMARY OF THE INVENTION

It is the object of the invention to provide a water sports device, the use of which can be more controllable and therefore safer.

According to the invention, the water sports device and in particular the propulsion device has at least one sensor arrangement which is usable for position determination, wherein a control unit of the water sports device is designed for generating control signals on the basis of signals from the sensor arrangement for the purpose of geofencing and/or homing.

One or more controllable elements of the water sports device are activated by means of the control signals. Said elements may include in particular a motor of the propulsion device, movable means for generating an alignment of a water jet (e.g. a wing, motor, rudder blade, a fin and/or nozzle), and/or retractable and extendable elements (a centerboard, a holding and/or hydrofoil device) which influence the floating properties of the water sports device.

In the present context, geofencing is understood to mean, in particular, the automatic generation and triggering of control signals when a predefined region of the body of water being navigated is left or a predefined and then in particular blocked region of the body of water being navigated is reached.

Homing is understood to mean, in particular, the automated activation of a deployment site or of a destination point of the water sports device on the basis of correspondingly generated control signals from a control unit or a monitoring unit.

Water sports devices according to the invention are designed in particular as diving propulsion vehicles, hydrofoil or foil boards or as bumper boats, i.e. large floatable rings provided with a controllable propulsion device. The water sports devices according to the invention are used in particular in the leisure and recreation sector.

The sensor arrangement has sensors known for the particular purpose. For example, according to a development of the invention, a position determination according to the invention, comprising the distance above ground, takes place in particular by means of sound-based methods and associated transmitting and receiving sensors, the signals of which are evaluated by the control unit.

The control unit includes conventional means for controlling the water sports device and in particular the propulsion device, such as a man-machine interface, electrical and/or electronic data processing means, and interfaces to any functional systems that may be present, such as sensors. A man-machine interface has in particular a headset comprising at least one head sensor for recording movements of at least part of the head of a person located during operation on the water sports device. This allows the arms and legs to be moved freely for balancing without holding any control means in the hand. For example, the propulsion speed can be increased or reduced by targeted movement sequences that can be established or are established in advance and that can be predefined or learned by the control unit, for example repeated nodding or shaking of the entire head. To detect this movement, the headset has an acceleration sensor in the form of a head sensor, for example.

In addition, the control unit preferably has an interface to a communications unit or this is integrated directly in the control unit. The control unit is preferably arranged in a housing or a recess of the floating body, but it can also be distributed in different regions of the water sports device. A bus system is preferably used for the communication of individual components of the water sports device.

In particular, the position determination comprises the determination of the geographical position, in particular comprising the degree of longitude and latitude. Against the background of available position sensors, which are used, for example, to detect signals from a GPS, Glonass, or Beidou system, control signals, such as a reduction in the engine power of a propulsion device, can be automatically generated when a predefined region is left.

Preferably, the sensor arrangement and/or the control unit are designed to determine the distance to a deployment site, such that corresponding control signals are generated, for example, when a maximum distance is reached. The distance to a deployment site can be determined, for example, by determining the position and defining the deployment location purely locally at the water sports device; it can also take place via bidirectional communication with a communication means available on the water sports device and at the deployment site, such that, for example, the distance can be determined via propagating times of the communications signals or the signal strength thereof.

Preferably, the sensor arrangement, which can generally comprise different sensors at different positions of the water sports device, is designed to determine the absolute or relative speed of the water sports device, such that, for example, when riding down relatively large waves, the associated acceleration can be assisted by increasing the power of the propulsion device.

For the purpose of generating control signals, the control unit preferably has means for comparing the position with an internally or externally predefined map. A map of the surroundings predefined in a data memory of the control unit can, for example, have no-drive zones, such that, when the determined position is compared with the map, a control signal is generated when a prohibited region is reached. In particular, when entering such a region, corresponding information can be output via a man-machine interface and, for example, a display with directions for reaching the next permitted region can be output.

Alternatively or additionally, on the basis of the position on a map and/or after a predefinable period of time has expired, a course for returning the water sports device to the deployment site can be calculated and automatically converted into corresponding control signals, such that the water sports device automatically returns to the deployment site or to a predefined destination point.

According to a further embodiment of the invention, an external monitoring device which is designed to transmit control signals generated on the basis of the position of the water sports device to the control unit is provided. Such an EDP-supported monitoring device comprises necessary communication means at the water sports device and at the external monitoring device, which is, for example, located on the bank. The monitoring device can also be present, for example, on a ship from which the water sports device sets out. Preferably, the no-drive zone can be generated dynamically on the basis of the ship's position, e.g. as a circle around the ship along the water surface with a diameter of 300 m.

The control unit is advantageously designed for communication with a control unit of a further propulsion device of the same or of a further water sports device. This results in a large number of interaction options between the two water sports devices and/or their users. For example, a teacher/pupil mode or a tandem mode for synchronous travel can be implemented. Tracking modes can also be implemented, in which case, for example, reaching a minimum, in particular predefinable, distance is evaluated as a success and the travel of the water sports devices is slowed down. The speeds of the two or more water sports devices can also be matched to one another or predefined within ranges. In particular, the control unit is designed for generating control signals for one or both propulsion devices on the basis of the position, control and/or driving signals/data transmitted by the further water sports device.

The possible uses of a water sports device according to the invention are extended if, according to a further development according to the invention, the water sports device has two propulsion devices, wherein a person region is present between the two propulsion devices in a top view. The person region is understood to be the region that is available for people to be located in during operation of the water sports device and in which one or more people can stand, kneel, lie and/or sit, for example.

A water sports device according to the invention preferably comprises a hydrofoil device which is fastened to the floating body by means of a holding device, wherein the hydrofoil device which is arranged on a link of the holding device has at least one, preferably at least two hydrofoils, and wherein, in the operating position and during a forward movement, owing to buoyancy brought about by the hydrofoil device, the floating body can be transferred into a position spaced apart from a water surface. This design provides the advantages described below for a water sports device designed as a foil board. Preferably, the water sports device is designed for transferring the hydrofoil device from the operating position below the floating body into a rest and/or starting position close to the floating body or at least partially in the latter on the basis of the position of the water sports device. In particular, owing to a distance above ground and/or a distance from a deployment site, the floating body can again be brought back out of its raised position from the water surface and into the water, which automatically slows down the travel. This can be brought about in particular by a drive described below or by a reduction in engine power, which is associated with a reduction in speed. For the latter, the holding device is movable as a function of the speed in the water, in particular via the water pressure exerted by it against any linkage of the holding device.

The water sports device preferably has a further link which is pivotably mounted on or in the floating body at one end and pivotably arranged on the hydrofoil device at the other end. In particular, the first link and the further link are arranged one behind the other in the direction of travel, at least in the operating position of the hydrofoil device. Alternatively or additionally, the first link and/or the second link is/are pivotably arranged in particular on the floating body and/or on the hydrofoil device or on a unit or receptacle rigidly connected thereto. In particular, therefore, at least one of the links is pivotably arranged on a receptacle for the at least one hydrofoil device or on a receptacle of the hydrofoil device. The pivot axes are in particular oriented transversely with respect to the direction of travel and, during operation, parallel to the water surface. As a result, the holding device can be designed as a parallelogram guide, which is particularly reliable and as a result of which the hydrofoil device remains below the floating body, in particular even in the rest and/or starting position.

Alternatively or additionally, the holding device preferably comprises further links, which are each coupled to one of the two links and, at least in the operating position, adjoin one another between the floating body and the hydrofoil device and transmit force to one another. In particular, the two first or further links are pivotable relative to one another, as a result of which a toggle lever or folding mechanism can be produced as the holding device. For example, in each case two links forming a knee joint are arranged one behind the other in the direction of travel.

As soon as sufficiently deep water is reached, the hydrofoil device can be transferred, in particular by means of a drive, into the operating position which is spaced further away from the floating body.

The water sports device is preferably designed in such a way that the propulsion device continues to provide propulsion during the transition of the hydrofoil device from the rest and/or starting position into the operating position and the travel of the water sports device does not slow down.

The drive of the holding device is preferably designed as an electro-mechanical or electro-pneumatic drive via which the hydrofoil device is transferable from a rest and/or starting position into the operating position and/or from the operating position into the rest and/or starting position, in particular is retractable and extendable and/or foldable.

In the rest and/or starting position, the hydrofoil device is arranged closer to the floating body than in the operating position, in order to make the water sports device more compact. In particular, parts of the holding and/or hydrofoil device that are remote from the floating body in the operating position can be partially arranged in at least one recess of the floating body in the rest and/or starting position. In particular, the holding device is folded in and/or, for example, retracted telescopically in order to transfer the hydrofoil device into the rest and/or starting position. In particular, the at least one, first link is pivoted by at least 20°, preferably by at least 40°, particularly preferably by at least 80°, in order to transfer the hydrofoil device relative to the floating body. Preferably, in the rest and/or starting position, the hydrofoils are spaced apart by no more than 50 cm from the floating body in a side view. Geofencing brought about automatically by the control unit and/or an external monitoring device is signaled to the user in particular by assuming the starting and/or rest position and/or by a reduction in the motor power.

The floating body is in particular a flat, elongate body, the density of which is significantly under that of water. The floating body is in particular designed in such a way that, during operation, it is at any rate partially arranged above the water surface, preferably independently of a travel speed. During operation, the holding device reaches from the floating body to the hydrofoil device below the floating body. A lifting force generated by the hydrofoil device is transmitted to the floating body by the holding device. In particular, it has a surfboard-like shape.

The drive preferably has an energy store, in particular for storing mechanical energy which, when released, provides the energy required for retracting and extending or folding the link. For example, the energy store comprises a rechargeable battery for storing electrical energy, a tank for storing a pressurized fluid or, in particular, a mechanical energy store, such as a spring. In a first embodiment of the invention, the energy store is designed to feed a drive motor, which initiates the transfer of the hydrofoil device. In a preferred further embodiment of the invention, the energy store releases stored energy directly, without an interposed drive motor, as mechanical or kinetic energy for the transfer. The energy store is preferably mechanically coupled to the holding device on the one hand and, on the other hand, directly or indirectly to a charging device, such as a drive motor, which is designed to charge the energy store, in particular while the water sports device is being used.

Preferably, at least part of the propulsion device, namely in particular a propulsion body housing, is detachably fixed to a receptacle of the hydrofoil device such that a propulsion energy store, for example a rechargeable battery, contained in the propulsion device can be easily replaced for repair or charging purposes. In particular, the impeller of the propulsion device is arranged in a corresponding flow channel in the propulsion body housing. The impeller is preferably designed as an impeller without a shaft or hub. The flow channel in the propulsion body housing is thus not narrowed by a corresponding shaft or hub.

A device according to the invention is also constructed to be operationally safer for the user if, according to a further development, it has a storage sensor for monitoring the propulsion energy store, wherein the water sports device is designed to reduce the power or to switch off the propulsion device on the basis of the signal from the storage sensor. In this way, for example, a draining of the rechargeable batteries can be avoided and a user can be signaled that they should return to a deployment site before the propulsion energy has been used up.

The propulsion device and thus the water sports device is preferably operable both in the rest and/or starting position and in the operating position, such that on the one hand different skill levels of any users can be taken into account and on the other hand a return to a permitted region or to the deployment site is possible.

In addition to the sensors required for geofencing, the propulsion device preferably comprises at least one sensor, preferably a plurality of sensors from a group comprising gyro sensors, speed sensors, (additional) position sensors (GPS, Glonass, Beidou, etc.), distance sensors, i.e. sensors for detecting the distance from objects or structures (in particular ultrasound, echo sounder, sonar), infrared sensors, and inclination sensors. Equipping the water sports device with one or more such sensors enables the formation of an “intelligent” water sports device, which not only makes its use more comprehensible by storing the sensor data in a corresponding memory, but in particular makes it more convenient, simpler and safer. For example, an additional position sensor for tracking the route or for improving the position determined for the geofencing, a speed sensor for adjusting the holding device and/or at least parts of the hydrofoil device, inclination sensors for balancing the water sports device in an operating position, and infrared sensors for detecting people located in the environment can be used. Depending on the sensor data, the water sports device can automatically make adjustments, e.g. to the travel speed, the height above the water surface or the position of the holding device. The control unit is also designed to process the signals from the sensors, in particular to form control signals, for one or more of these processes. It goes without saying that the control unit also has corresponding or identical data processing means, operating energy stores (in particular one or more rechargeable batteries or liquid energy stores) and communication means including a man-machine interface, for this purpose.

As an alternative or in addition to a depth sensor with which the immersion depth of the water sports device is detected, a development of a water sports device according to the invention comprises at least one motion status sensor for determining the distance of the floating body from the water surface. Depth and motion status sensors can also be formed by a single sensor or a single sensor arrangement.

In particular, the motion status sensor is a sensor unit that is preferably integrated in a link of the holding device or is arranged on this or these. For example, it can be a sensor strip that extends along a link of the holding device or is integrated therein over the length of the link and operates on a capacitive basis. It can also be a sensor unit with a plurality of, in particular, capacitive sensors, which are arranged spaced apart from one another along the holding device, for example in or on the link thereof. If the position of the holding device or the link thereof is known, the sensor data can be used to infer the distance of the floating body to the water surface by means of the control unit, and in particular in combination with other sensor data, for example on the travel speed and/or the depth of the water, a desired travel state can be sought, for example by raising or lowering the floating body by adjusting one or more hydrofoils or by actuating the holding device or by changing the driving speed. This can also be done depending on the information about the position of the water sports device, in particular whether it is in a permissible region or outside said permissible region. It goes without saying that such a motion status sensor, which is arranged as an individual sensor or as a sensor unit comprising a plurality of sensors in the holding device or on the latter, can also be used on holding devices arranged rigidly on the floating body, in which the holding device both in the operating position and in the rest and/or starting position keeps the hydrofoil device in the same position with respect to the floating body.

In particular, the motion status sensor is laminated into place, wherein the link of the holding device that has the sensor is preferably produced from a fiber composite material, such that on the one hand a stable design of the link is achieved and on the other hand the integration of the motion status sensor is simplified at the same time. With printing processes such as screen printing, dispensing or inkjet printing, tailor-made sensor structures can be applied directly to the fleece or fabric to be used, with the motion status sensor becoming an integral part of the structure of the holding device through the integration of the printed fleece or fabric in the layer structure and subsequent fiber composite production, e.g. by vacuum infusion.

A water sports device equipped with a motion status sensor, in particular in the form of a hydrofoil board, preferably has an optical display unit which in particular extends over at least half the length of the upper side of the floating body and which is designed in particular to display the distance of the floating body to the water surface. Preferably, the distance from the water surface can, for example, correlate with the number and/or arrangement of the luminous points of the display unit in order to permit a sufficiently large display that can be read quickly even during travel. In particular, RGB diodes can be used for this purpose. In particular, the optical display unit can be part of the man-machine interface or represents one such interface. For example, when the floating body rests on the water, no or only a few, e.g. red lamps are illuminated, and, as the distance becomes greater, the number and/or color of the illuminating lamps over the floating body length is/are changed until, at a desired state, a certain, for example, maximum number of lamps is activated. For example, a certain, desired or optimal distance to the water surface can be marked with predominantly or exclusively green illuminating lamps in the form of RGB diodes, for example. Depending on the number and arrangement of the lamps integrated in the floating body, a directional arrow for homing or geofencing can also be displayed.

The propulsion device and the control unit are preferably designed for in particular automatic thrust control, further in particular for automatic thrust vector control. As a result, an additional control option is made available to a user, such that, for example, particularly tight curves can be driven or even jumps can be made. In an automated embodiment, in connection with in particular position sensors, such as gyrometers, the water sports device is self-stabilizing, particularly in the operating position. The control unit thus compensates for instabilities, which enables beginners in particular to have a better driving experience faster. In particular, the control unit is designed to self-stabilize the water sports device by means of thrust vector control during the transition to the operating position and/or when the floating body is lifted from the water surface, since the user is greatly influenced during these phases.

In particular, for thrust control, the propulsion device is provided with a vector nozzle, i.e. an orientable nozzle forming the outlet opening of the flow channel.

Preferably, the water sports device comprises a propulsion device which is provided for the propulsion thereof and the propulsion motor of which, which is arranged on the floating body side, is connected in terms of drive to a propulsion element via an angularly movable propulsion train. As a result, the hydrofoil device can be constructed in a more streamlined manner.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows the subject matter according to the invention in a side view.

FIG. 2 shows the subject matter according to FIG. 1 in a view from the rear.

FIG. 3 shows the subject matter according to FIG. 1 in a use situation.

FIG. 4 shows two subjects according to the invention in a further use situation.

FIG. 5 shows further subject matter according to the invention in a perspective view.

FIG. 6 shows the subject matter according to FIG. 5 in a starting and/or rest position.

FIGS. 7 and 8 show further subject matter according to the invention.

### DETAILED DESCRIPTION OF THE DRAWINGS

Individual technical features of the exemplary embodiments described below may also result, in combination with the features of the independent claim, in developments according to the invention. Where expedient, functionally equivalent parts are provided with identical reference signs.

A water sports device 2 according to the invention comprises a floating body 4 which is connected to a holding device 8 via a hydrofoil device 6. The hydrofoil device 6 comprises a plurality of links 10 which are arranged at one end in an articulated manner on the floating body 4 and at the other end in an articulated manner on the hydrofoil device 8. Via an internal drive 12 shown in dashed lines, the front links 10 in the direction of travel F, which are arranged on a common shaft, are moved. Via the coupling by means of a propulsion device 50 of the hydrofoil device 6, the rear links 10 in the direction of travel F are positively guided. In this respect, only a single, sufficiently dimensioned drive 12 is necessary.

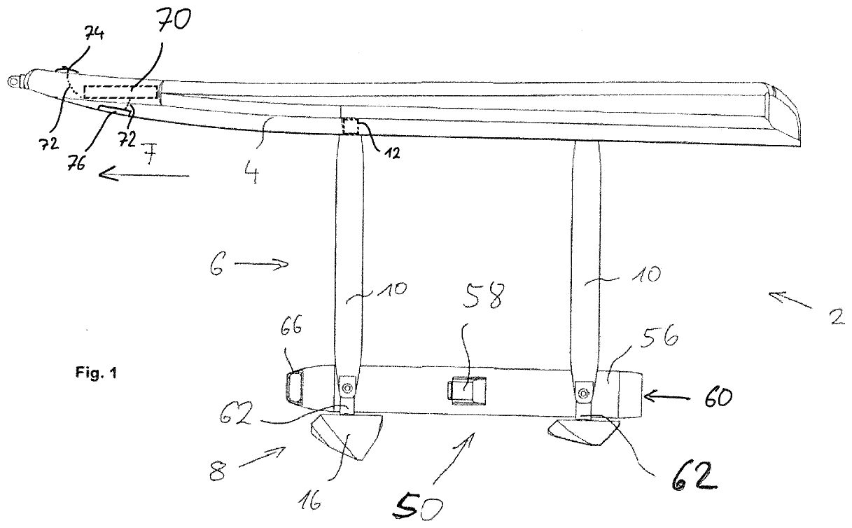

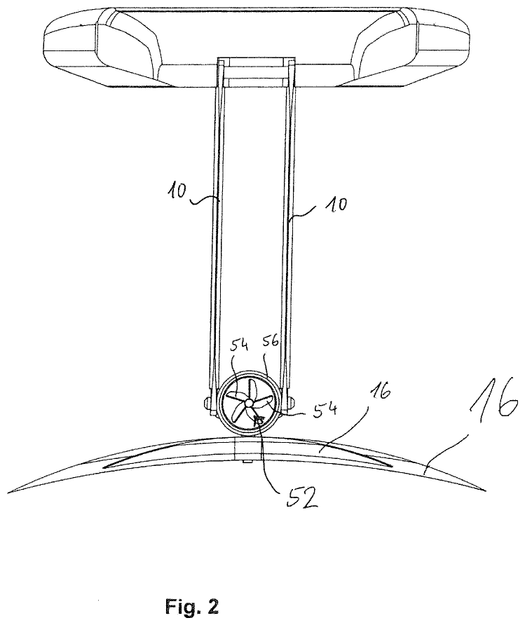

The links 10 are designed to be flow-optimized with a smaller extent, as viewed in the direction of travel F, than transversely thereto (FIGS. 1 and 2). In addition, the inflow surfaces are rounded and the cross section of the links is designed in particular in the form of a drop or a wing.

In the present case, the propulsion device 50 is designed with a hubless impeller 52 (FIG. 2). The associated motor has a rotor, the inside of which forms the flow channel, and which is correspondingly hollow, with the blades 54 being fastened to the inside of the rotor. The rotor is mounted outside the flow channel on its outer side directed away from the flow channel and runs in a stator which is arranged in a propulsion body housing 56.

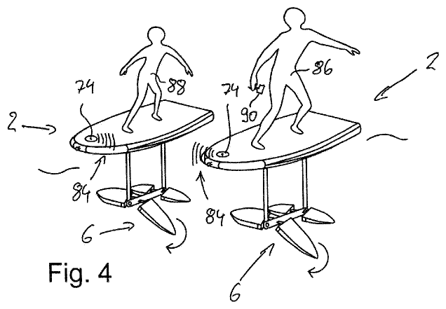

Two laterally protruding housing walls 58 (cf. FIG. 1) delimit two openings which are designed as inlet openings and are located on surfaces facing away from one another and through which the water ultimately expelled and accelerated through the outlet opening 60 reaches the inner flow channel beforehand. The propulsion device comprises the propulsion body housing 56 fixed in two receptacles 62 with an internal propulsion energy store, the motor designed as an internal rotor, including the propulsion element designed as a hubless impeller, and a control unit 70, which is designed with a man-machine interface for operating the propulsion device 50. Corresponding line means lead, for example, through the holding device 8 into the floating body 4 and are transmitted from there, for example wirelessly, to a hand-held device 90 of the user 86 operating the water sports device 2 (FIG. 4). The hand-held device 90 is part of the control unit 70 or is connected wirelessly thereto.

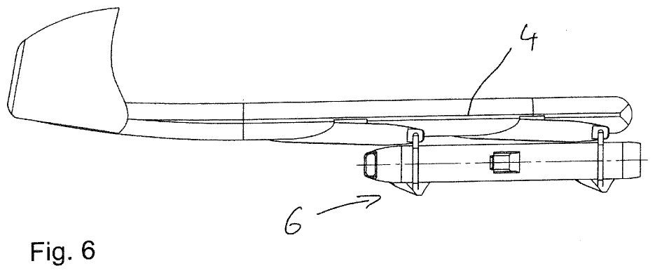

Such a hand-held device can be used, for example, to release or trigger the transfer of the hydrofoil device 6 with its hydrofoils 16 from the operating position shown into a starting and/or rest position, shown in FIG. 6, of the hydrofoil device 6 closer to the floating body 4.

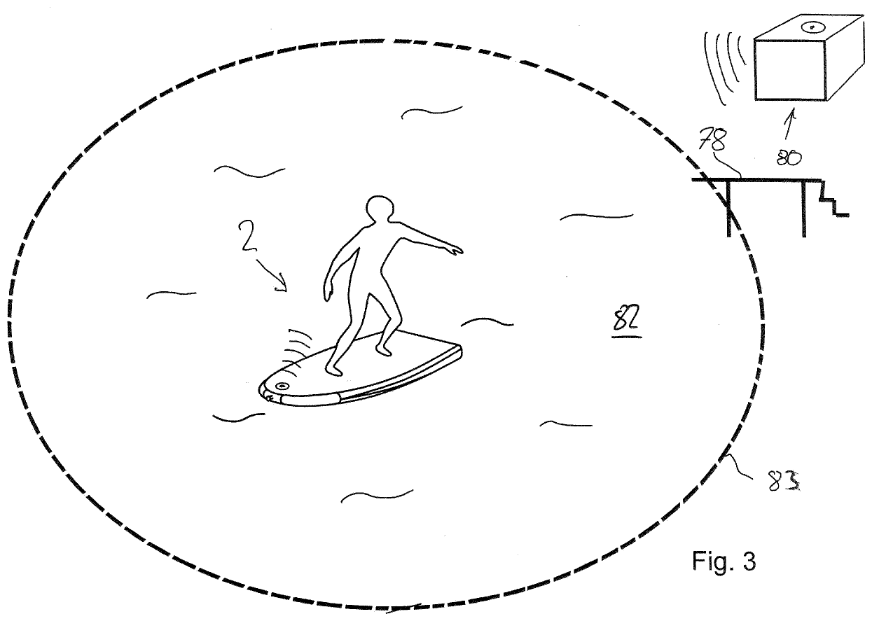

According to the invention, the transfer can be effected automatically, for example, by control signals from a control unit 70, which is arranged in the floating body 4 and is therefore only shown in dashed lines, on the basis of its evaluation within the scope of the geofencing (FIG. 1). For this purpose, the control unit 70 receives signals from a sensor arrangement 74 via a signal line 72 shown dotted, with the sensor arrangement 74 comprising at least one sensor. Control signals are generated on the basis of these signals when an internally or externally predefined region in which the water sports device 2 may be driven is left. A control signal is automatically generated in the control unit 70 (cf. FIG. 3) only when a predefined limitation 83 of a region of use 82 of the water sports device 2 is left. This can be caused, for example, by the transition of the hydrofoil device 6 to the rest and/or starting position of the hydrofoil device 6 and, for example, by a throttling of the drive power of the propulsion device 50. For this purpose, the sensor arrangement is designed, for example, to record GPS signals or other localization signals and/or the distance above ground by means of a sound signal. For the latter, the underside of the floating body 4 has corresponding transmitting and receiving units 76. These are also coupled again to the control unit 70 via a corresponding signal line 72.

The foil board shown in FIGS. 1 and 2 can then be transferred back again to its deployment site in a manner controlled by weight shifting, even in the position shown in FIG. 6 for another exemplary embodiment. Alternatively or in addition, the foil board can also be designed according to FIG. 3 to determine the distance to a deployment site 78. For this purpose, for example, the transmission duration of a time-coded signal between a central monitoring device 80 assigned to the deployment site 78 and the water sports device 2 is determined. Such a monitoring device 80 can also be used by a user who has appropriate access rights to exercise further control options, in particular if the water sports device leaves a region of use 82 beyond its boundary 83.

The sensor arrangement 74 can also be supplemented by a communications unit, via which the control units 70 of two water sports devices 2 that are correspondingly in a synchronous mode with one another can communicate with one another, indicated by the signals 84 represented by a plurality of curved lines. In such a mode, for example, a person 86 qualified as an instructor can give a trainee 88 driving signals by means of the hand-held device 90 connected wirelessly to the control unit 70, said signals leading, for example, to the initiation of cornering by folding down the movable hydrofoils 16 of the hydrofoil device 6. In addition, the region of use of the water sports devices 2 is limited to a region 82 defined by geofencing by the correspondingly programmable control unit 70 (not shown here).

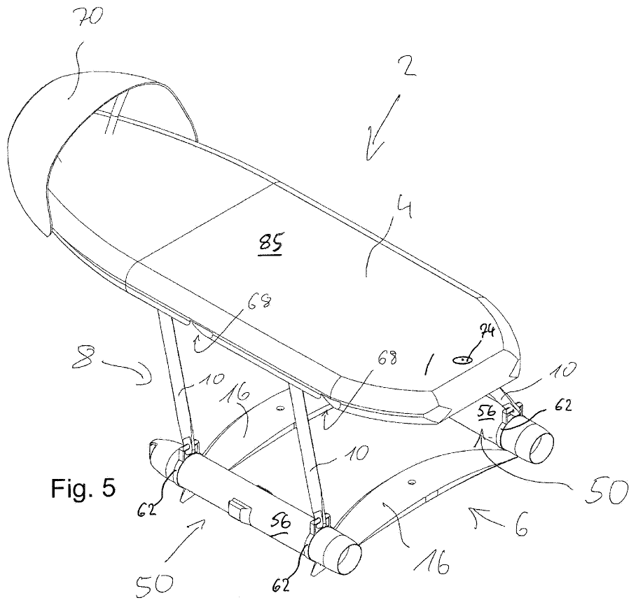

In principle, the further arrangement according to the invention according to FIG. 5 has the same effect. This water sports device 2, which is larger than that in FIG. 1, is likewise designed as a foil board which, however, is configured for use with two people in the people region 85. The hydrofoils 16 of the hydrofoil device 6 are located essentially between the propulsion devices 50, at least in a top or bottom view. The hydrofoil device 6 here comprises receptacles 62 for the propulsion devices 50, on which links 10 of the holding device 8 are arranged. These pivot from the operating position shown into a rest or starting position in which the propulsion device 50 is arranged closer to the floating body 4 and the links 10 are at least partially arranged in the recess 68 of the floating body 4 (FIG. 6). A screen 71 is arranged on the floating body 4 for better protection of the person standing or lying on the foil board. In the present case, the sensor arrangement 74 is located at the rear end of the foil board, in which the control unit 70 is also arranged. This is connected via signal and supply lines (not shown) to a rechargeable battery or to a propulsion storage unit of the propulsion devices 50, which are in each case arranged in the front part of the torpedo-shaped propulsion devices 50 within the propulsion body housing 56.

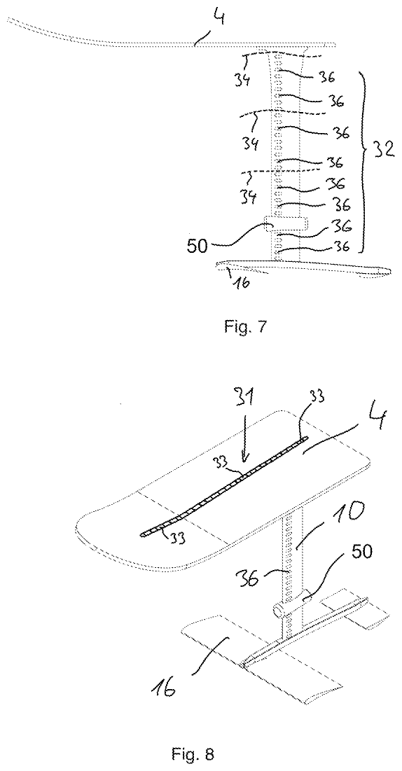

According to a further exemplary embodiment according to the invention, a plurality of capacitive sensors 36 are arranged along a link 10 of the holding device 8 to form a motion status sensor 32 (FIGS. 7 and 8). These extend uniformly over a large part of the link 10 along its longitudinal extent and, depending on whether they are arranged above or below a water surface 34 indicated in each case by dashed lines, send corresponding data to a control unit preferably arranged in the floating body 4. This allows the distance of the floating body 4 to the water surface 34 to be determined, whereupon, in the event of undesired conditions, the control unit can adjust, for example, the thrust of the propulsion device 50, which is integrated in the link 10, or an angular position of a hydrofoil 16.

The exemplary embodiment in FIGS. 7 and 8 also has an optical display unit 31 which is integrated in the floating body and which displays the distance of the floating body 4 to the water surface. The display unit 31 comprises a plurality of multicolored LED units 33 which are laminated into place, such that the distance to the water surface 34 can be displayed via the number and/or wavelength of the LED units 33 that are illuminated.

1. A water sports device comprising:
a floating body, and
a propulsion device provided for propelling the water sports device,
at least one sensor arrangement which is usable for position determination, said at least one sensor arrangement being configured together with a control unit for generating control signals on the basis of signals from the sensor arrangement for the purpose of geofencing and/or homing.

2. The water sports device as claimed in claim 1, wherein the position determination comprises the distance above ground.

3. The water sports device as claimed in claim 1, wherein the position determination comprises the determination of the geographical position.

4. The water sports device of claim 1, wherein the sensor arrangement and/or the control unit determines the distance to a deployment site.

5. The water sports device of claim 1, wherein the sensor arrangement determines the absolute or relative speed of the water sports device.

6. The water sports device of claim 1, wherein the control unit has means for comparing the position with an internally or externally predefined map for the purpose of generating control signals.

7. The water sports device of claim 1, further including an external monitoring device which is designed to transmit control signals generated on the basis of the position of the water sports device to the control unit.

8. The water sports device of claim 1, wherein the control unit is designed for communication with a control unit of a further propulsion device of the same or of a further water sports device.

9. The water sports device of claim 1, further including a second propulsion device, and a person region present between the two propulsion devices in a top view.

10. The water sports device of claim 1, further including a hydrofoil device which is fastened to the floating body by a holding device, wherein the hydrofoil device is arranged on a link of the holding device and has at least one hydrofoil, and wherein, in the operating position and during a forward movement, owing to buoyancy brought about by the hydrofoil device, the floating body can be transferred into a position spaced apart from a water surface.

11. The water sports device of claim 10, wherein the water sports device is designed for transferring the hydrofoil device from the operating position below the floating body into a rest and/or starting position close to the floating body or at least partially in the latter on the basis of the position of the water sports device.

12. The water sports device of claim 10, wherein the holding device has a further link which is pivotably mounted on or in the floating body at one end and pivotably arranged on the hydrofoil device at the other end.

13. The water sports device as claimed in claim 12, wherein the holding device has a drive via which the hydrofoil device is transferable from a rest and/or starting position into the operating position and/or from the operating position into the rest and/or starting position.

14. The water sports device of claim 13, wherein the drive has an energy store.

15. The water sports device of claim 10, wherein at least part of the propulsion device is detachably fixed to a receptacle of the hydrofoil device.

16. The water sports device of claim 1, further including a propulsion energy store of the propulsion device and a storage sensor for monitoring the propulsion energy store, wherein the water sports device is designed to reduce the power or to switch off the propulsion device on the basis of the signal from the storage sensor.

17. The water sports device of claim 11, wherein the propulsion device is operable both in the rest and/or starting position and in the operating position.

18. The water sports device of claim 1, wherein the water sports device has at least one sensor.

19. The water sports device of claim 1, wherein the propulsion device is designed for thrust control, and the control unit of the water sports device is designed for this purpose.

20. The water sports device of claim 26, wherein the control unit is designed for self-stabilization of the water sports device by means of the thrust vector control.

21. The water sports device of claim 10, wherein the propulsion device has a vector nozzle.

22. The water sports device of claim 1, further including a motor of the propulsion device which is arranged on the floating body side and which is connected in terms of drive to a propulsion element via an angularly and/or longitudinally movable propulsion train.

23. The water sports device of claim 10, further including at least one motion status sensor for determining the distance of the floating body and/or of the hydrofoil device from the water surface.

24. The water sports device of claim 1, further including an optical display unit.

25. The water sports device of claim 19, wherein the propulsion device is designed for automatic thrust control.

26. The water sports device of claim 19, wherein the propulsion device is designed for automatic thrust vector control.
